(19) United States
(12) Patent Application Publication
(10) Pub. No.: US 2021/0312133 A1
(43) Pub. Date: Oct. 7, 2021

(54) WORD VECTOR-BASED EVENT-DRIVEN SERVICE MATCHING METHOD

(71) Applicant: SOUTH CHINA UNIVERSITY OF TECHNOLOGY, Guangdong (CN)

(72) Inventors: Fagui LIU, Guangdong (CN); Dacheng DENG, Guangdong (CN)

(73) Assignee: SOUTH CHINA UNIVERSITY OF TECHNOLOGY, Guangdong (CN)

(21) Appl. No.: 17/266,979

(22) PCT Filed: Oct. 31, 2018
(86) PCT No.: PCT/CN2018/113227

§ 371 Date: Feb. 8, 2021

(30) Foreign Application Priority Data
Aug. 31, 2018 (CN) 201811014545.2

(51) Int. Cl. G06F 40/30; G06F 40/242; G06N 20/00

(52) U.S. Cl. CPC G06F 40/30; H04L 67/12; G06N 20/00; G06F 40/242

(57) ABSTRACT

Disclosed in the invention is a word vector-based event-driven service matching method, including: implementing a mixed word vector training algorithm and an event-driven service matching model. In the mixed word vector training algorithm, in consideration of an influence of a word frequency on word vector training, according to an adjacency relationship between words in a corpus and a semantic relationship between words in a dictionary, high-frequency word processing, low-frequency word processing and joint processing, are used for training to obtain word vectors. The event-driven service matching model defines two event-related services: an event recognition service and an event handling service, a matching degree of the two services is calculated by the word vectors, and when the matching degree is higher than a given threshold, the matching is successful. The invention is able to improve a quality of the word vectors and further improve the accuracy and efficiency of service matching.

### BACKGROUND

### Technical Field

The invention belongs to the field of event-driven service discovery in semantic Internet of Things (IoT), and more particularly, relates to a word vector-based event-driven service matching method.

### Description of Related Art

In an environment of Internet of Things (IoT), an event reflects a state change of an observed object. A key to respond to the event quickly through services is to match a service available for response according to the event. A service in semantic IoT is a product of semantic description on a service of the IoT by a semantic web technology. Different from traditional service discovery, a service requester is the event in the environment of the IoT instead of an explicitly indicated service request. At present, a relationship between the event and the service is mainly constructed through manual selection, predefined rules, and other forms, so as to achieve a purpose of service matching. However, these modes rely heavily on prior knowledge, and when categories and numbers of the event and the service are increased, an accuracy and an efficiency of the service matching will face great challenges. Therefore, automatic event-driven service matching through a semantic technology has become an urgent problem to be solved.

In semantic-based service matching, calculation of a similarity between the service and the request may be used as an important basis for the service matching. When a semantic similarity is calculated, a structured knowledge base or an unstructured corpus is usually utilized. According to a corpus-based method, word vectors may be learned from a large number of corpora, and the service matching is performed by calculating a similarity of the word vectors. This kind of method is characterized by a sufficient vocabulary coverage, with a low training cost of the word vectors. At present, in a model for training the word vectors, Mikolov et al. proposed a continuous bag of words model (CBOW). The model models a training process of the word vectors as a neural network, and uses context information of words in the corpus (n adjacent words before and after the word) as an input of the neural network according to an N-Gram model, and the word vectors are trained by maximizing a log likelihood of the words. Finally, implicit semantics of the words are projected into a low-dimensional and continuous vector space. In order to further improve a quality of the word vectors, some researchers propose to integrate the knowledge base into the training of the word vectors, so that the trained word vectors carry more semantic information. Lu et al. put forward a multiple semantic fusion model (MSF). The model fuses the semantic information into the word vectors through different vector operations, and then uses the obtained word vectors to calculate the similarity between the service and the request. The similarity is used as a main basis of the service matching. Faruqui et al. put forward a retrofitting model. The model performs secondary training on the existing word vectors by a semantic relationship between words in the dictionary, so as to achieve a purpose of inputting the semantic information into the word vectors. However, most word vector training methods do not consider an influence of a word frequency on training results currently, and all words are processed in the same way. Therefore, Wang et al. pointed out that when the word vectors were trained, compared with high-frequency words, low-frequency words might have a poor training effect due to less context information.

### SUMMARY

In order to improve an efficiency and an accuracy of event-driven service matching, the present invention provides a word vector-based event-driven service matching method, which differentiates high-frequency words and low-frequency words and provides a mixed word vector training algorithm, and a continuous bag of words model (CBOW) is employed to train in a high-frequency word processing stage to obtain high-frequency word vectors, a semantic generation model (SGM) is employed to construct in a low-frequency word processing stage to obtain low-frequency word vectors, and a cosine similarity retrofitting model (CSR) is employed to perform joint optimization on the high-frequency word vectors and the low-frequency word vectors in a joint processing stage, so as to acquire high-quality word vectors. An event recognition service and an event handling service are defined, an event-driven service matching model is built, and a service matching degree is calculated through the word vectors, thus solving a problem of automatic service matching, and improving the efficiency and the accuracy of the service matching.

The present invention is implemented by following technical solutions.

A word vector-based event-driven service matching method includes two parts of: acquiring high-quality word vectors by a mixed word vector training algorithm; and performing event-driven service matching by using an event-driven service matching model. The step of acquiring the high-quality word vectors by the mixed word vector training algorithm comprises: dividing words into high-frequency words and low-frequency words, and obtaining word vectors through three stages, including high-frequency word processing, low-frequency word processing and joint processing, by an adjacency relationship between words in a corpus and a semantic relationship between words in a dictionary. The event-driven service matching model defines two event-related services which include an event recognition service and an event handling service, and calculates a matching degree between the services by using the word vectors; when the matching degree is higher than a given threshold, the matching is successful.

Further, in the high-frequency word processing stage, according to the adjacency relationship between the words in the corpus, a continuous bag of words model (CBOW) is employed for training to obtain high-frequency word vectors.

Further, in the low-frequency word processing stage, according to the semantic relationship between the words in the dictionary and the obtained high-frequency word vectors, a semantic generation model (SGM) is employed to construct low-frequency word vectors.

Further, in the joint processing stage, a cosine similarity retrofitting model (CSR) is employed to perform joint optimization on high-frequency word vectors and low-frequency word vectors.

Further, in the event-driven service matching model, an Event is respectively used as an output of an event recognition service (ERS) and an input of an event handling service (EHS), which are expressed as Event⊆ERS·hasOutput and Event⊆EHS·hasInput by a description logic (formal expression of a relationship between concepts), wherein Event represents a concept of the event, ERS represents a concept of the event recognition service, EHS represents a concept of the event handling service, hasOutput represents an output relationship, and hasInput represents an input relationship; and the service matching model is given as follows:

$$match ( ERS , EHS ) = \{ \begin{matrix}1 & Sim ( {E}_{r} , {E}_{h} ) \geq τ \\ 0 & others\end{matrix} ;$$

wherein Eᵣ and Eₕ are both events, which respectively represent the output of the event recognition service and the input of the event handling service, r represents a threshold, and Sim(Eᵣ, Eₕ) represents the matching degree serving the event recognition service and the event handling service.

Further, the service matching degree Sim(Eᵣ, Eₕ) is expressed as:

$$Sim ( {E}_{r} , {E}_{h} ) = {\sum }_{a ∈ attr ( {E}_{r} )} {W}_{a} \cdot {Sim}_{a} ( {E}_{r}^{a} , {E}_{h} )$$

wherein a represents a certain attribute of the event, attr(Eᵣ) represents an attribute collection of Eᵣ, and Wₐ represents a weight of the attribute a, which is specifically

$${W}_{a} = \frac{1}{\vert attr ( {E}_{r} ) \vert} ;$$

the Simₐ(Eᵣ^{a}, Eₕ) represents a similarity of Eᵣ between attributes a and Eₕ, which is specifically:

$$S i {m}_{a} ( {E}_{r}^{a} , {E}_{h} ) = \{ \begin{matrix}1 , & {E}_{h} = ∅ \\ 0 & {E}_{h} \neq ∅ ⩔ \vert {E}_{r} \vert ≺ \vert {E}_{h} \vert \\ max \{ sim ( {E}_{r}^{a} , {E}_{h}^{i} ) \vert i ∈ attr ( {E}_{h} ) \} & others\end{matrix} ;$$

wherein sim(Eᵣ^{a}, Eᵣ) represents a similarity between the attribute a of the event Eᵣ and a attribute i of the event Eₕ, which is obtained by calculating a cosine similarity between the word vectors corresponding to the attributes, which is specifically:

$$s i m ( {E}_{r}^{a} , {E}_{r}^{i} ) = Cos Si m ( x , y ) = \frac{x \cdot y}{‖ x ‖ \cdot ‖ y ‖}$$

wherein x and y respectively represent word vectors corresponding to Eᵣ^{a} and Eᵣⁱ, and ∥x∥ and ∥y∥ respectively represent modules of x and y.

Compared with the prior art, the present invention has the following advantages and technical effects.

According to the present invention, an influence of a word frequency on training results is fully considered during word vectors training, the word vectors of the high-frequency words and the low-frequency words are obtained by using the CBOW Model and the SGM respectively, and then the word vectors are optimized through the CSR Model; and with the help of the obtained word vectors, the event-driven matching model is built to implement automatic service matching. The present invention is able to improve a quality of the word vectors and further improve an accuracy and an efficiency of service matching.

### BRIEF DESCRIPTION OF THE DRAWINGS

FIG. 1 is a framework diagram of word vector-based event-driven service matching.

FIG. 2 is diagram of a mixed word vector training algorithm.

FIG. 3 is a schematic diagram of a CSR Model.

### DESCRIPTION OF THE EMBODIMENTS

In order to demonstrate the technical solutions and the advantages of the present invention clearer, further detailed description is made hereinafter with reference to the drawings. However, the implementation and the protection of the present invention are not limited to this, it shall be noted that if there is any process that is not specifically described in detail hereinafter, it may be implemented or understood by those skilled in the art with reference to the prior art.

1. Framework of Event-Driven Service Matching

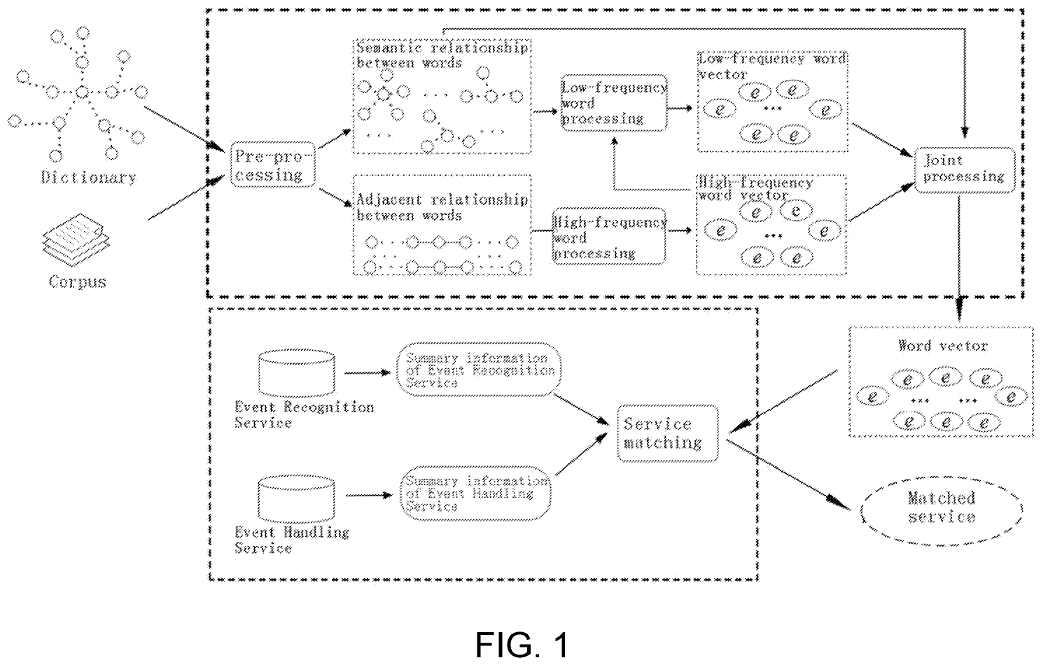

As shown in FIG. 1, the framework of the event-driven service matching provided in the embodiment includes two parts of: mixed word vector training and service matching. Firstly, in consideration of an influence of a word frequency, high-quality word vectors are trained from a corpus and a dictionary through a mixed word vector training algorithm. Then, automatic service matching is completed by using the obtained word vectors with the help of an event-driven service matching model.

2. Mixed Word Vector Training Algorithm

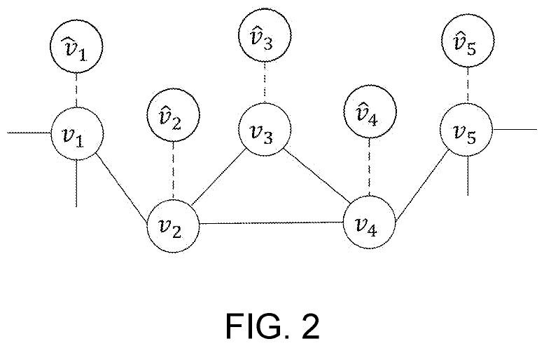

The mixed word vector training algorithm is shown in FIG. 2, which includes three stages of high-frequency word processing, low-frequency word processing and joint processing. In the high-frequency word processing stage, a CBOW Model is employed for training to obtain high-frequency word vectors; in the low-frequency word processing stage, a SGM Model is employed to construct low-frequency word vectors; and in the joint processing stage, joint optimization is performed on high-frequency word vectors and low-frequency word vectors by using a CSR Model, so as to acquire final word vectors.

2.1 High-Frequency Word Processing Stage

In the high-frequency word processing stage, an adjacency relationship between words is obtained from the corpus, and then the CBOW Model is employed to train. A core idea is to use a joint probability of a set of words to judge a possibility that the words conform to laws of natural language. The training aims to maximize an occurrence probability of all words in the corpus. For a word wₜ in a vocabulary, an objective function is a log-likelihood function, which is expressed as follows:

$$Obj = \frac{1}{T} {\sum }_{t = 1}^{T} log p ( {w}_{t} \vert {w}_{t - c}^{t + c} ) .$$

Wherein we is a target word, T is a total number of words in the corpus, w_{t-c}^{t+c}={w_{t-c}, . . . wₜ₋₁, wₜ₊₁, . . . w_{t+c}} represents a context of the word wₜ, c represents a size of a window (i.e., c words before and after wₜ are used as the context), when c=5, context information may be fully expressed, and p(wₜ|w_{t-c}^{t+c}) is expressed as a formula:

$$p ( {w}_{t} \vert {w}_{t - c}^{t + c} ) = \frac{exp ( {\hat{e} ( {w}_{t} )}^{⊤} \cdot {Σ}_{- c \leq i ⪡ c , i \neq 0} e ( {w}_{t + i} ) )}{{Σ}_{j = 1}^{N} exp ( {\hat{e} ( {w}_{j} )}^{⊤} \cdot {Σ}_{- c \leq i ⪡ c , i \neq 0} e ( {w}_{t + i} ) )} .$$

Wherein ê(w) and e(w) respectively represent input and output word vectors of a word w in the CBOW Model, and N represents a total number of words in the vocabulary. Specific training steps are as follows.

1) For each high-frequency word in the corpus, a word vector thereof is initialized, and a dimension D=400 of the word vector is set, which means that an expression requirement is already met, and an amount of calculation is moderate.

2) A context of any high-frequency word is extracted from the corpus as the input, and the log-likelihood function is maximized through a back-propagation algorithm, so as to modify the word vector.

3) The step 2) is repeated until all high-frequency words in the corpus are trained to obtain the word vectors of the high-frequency words.

2.2 Low-Frequency Word Processing Stage

In the low-frequency word processing stage, a semantic generation model (SGM) is provided by using a semantic relationship between <high, low> frequency words in the dictionary and the word vectors obtained in the high-frequency word training stage to construct the word vectors of the low-frequency words. The SGM is shown as follows:

$$e ( w ) = {\sum }_{k = 1}^{n} {ω}_{k} {\sum }_{{ω}_{i} ∈ {R}_{k}^{w}} e ( {w}_{i} ) .$$

Wherein n represents a number of categories of the semantic relationships, and ωₖ is expressed as a weight of each semantic relationship. When four relationships are considered, ωₖ=0.25 is set, which means that the relationships are equally important. Rₖ^{w} represents a collection formed by all high-frequency words having a semantic relationship Rₖ with the low-frequency words, e(wᵢ) represents a word vector of a word wᵢ, and e(wᵢ) comes from the word vectors obtained in the high-frequency word processing stage. Specific processing steps are as follows.

1) For each low-frequency word w and any semantic relationship Rₖ, high-frequency words having a relationship Rₖ with the word w are extracted from the dictionary to form a collection Rₖ^{w}.

2) The SGM is employed to construct word vectors e(w) of w.

2.3 Joint Processing Stage

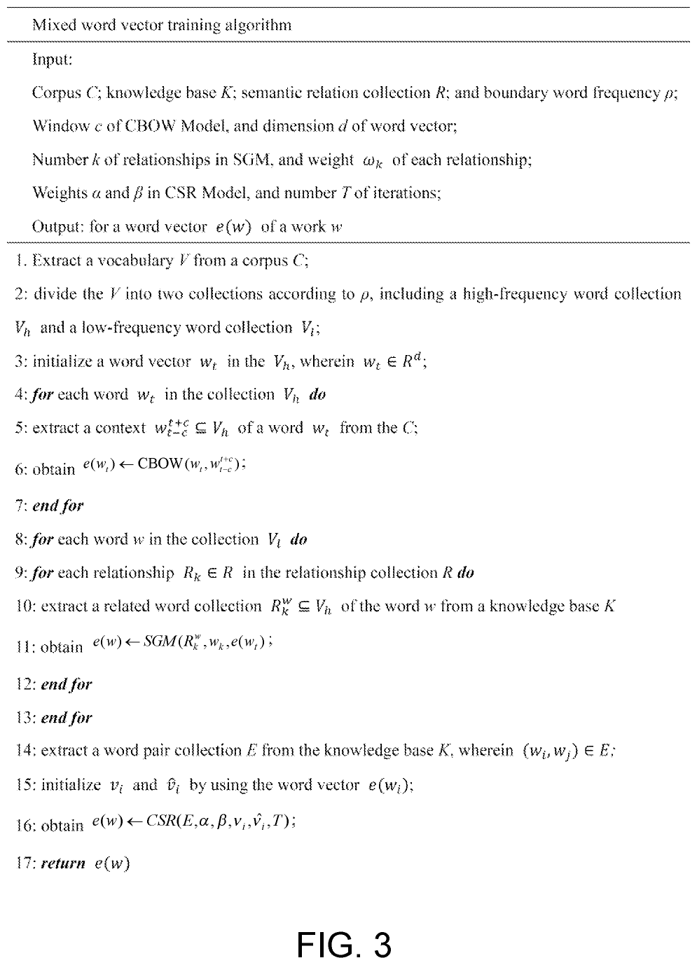

After obtaining initial high-frequency and low-frequency word vectors, only a semantic relationship between <high, low> frequency words in a knowledge base is utilized. In order to make full use of the knowledge base to modify the initial vectors, the joint processing is performed on the word vectors of the high-frequency words and the low-frequency words, so as to integrate information of two semantic relationships of <high, high> and <low, low> into the word vectors. The present invention provides a cosine similarity retrofitting model (CSR) to optimize the word vectors. A core idea of the model is to implicitly map a relationship between words into an image, and make a collection W={w₁, w₂, . . . w_{N}} represent words in the vocabulary, a word vector corresponding to a word represents a vertice V, and a semantic relationship collection of the words E=(wᵢ, wⱼ)⊆W×W represents an edge in the image. A simple example of the CSR Model is as shown in FIG. 3, \hat{ν}ᵢ and νᵢ respectively represent an initial word vector and a modified word vector of the word wᵢ, and a solid line edge is a sub-collection of E.

The model aims to make the modified word vector closer to a corresponding word vector thereof, and a similarity between word vectors having the semantic relationship is stronger.

We evaluate a correlation strength between the words by the cosine similarity herein, and the greater the similarity is, the stronger the correlation is. A formula for defining a correlation degree of all words in the vocabulary is expressed as:

$$Φ ( v ) = {\sum }_{i = 1}^{N} [ α \cdot Cos Sim ( {ν}_{i} , {\hat{v}}_{i} ) {\sum }_{( {w}_{i} , {w}_{j} ) ∈ E} β \cdot Cos Sim ( {v}_{i} , {v}_{j} ) ] .$$

Wherein N represents a number of words in the vocabulary, \hat{ν}ᵢ represents a word vector of the word wᵢ, νᵢ represents a modified word vector of the word wᵢ, νⱼ represents a modified word vector of a word wⱼ adjacent to the word wᵢ, α and β represent weights of two correlations, α=β=0.5 is set, which represents that the two correlations are equally important, CosSim(νᵢ, \hat{ν}ᵢ) represents a cosine similarity between the modified word vector νᵢ and the word vector \hat{ν}ᵢ, and CosSim(vᵢ, vⱼ) represents a cosine similarity between the modified word vectors νᵢ and νⱼ.

Then, an approximate optimal solution of a correlation degree formula is obtained through a gradient ascending method, and iterative steps are as follows.

1) Partial derivation is performed on vᵢ in the correlation formula to obtain a formula as follows:

$$\frac{\partial Φ ( v )}{\partial {v}_{i}} = α \cdot ( \frac{1}{\vert {v}_{i} \vert \cdot \vert {\hat{v}}_{i} \vert} \cdot {\hat{v}}_{i} - \frac{Cos Sim ( {v}_{i} , {\hat{v}}_{i} )}{{\vert {v}_{i} \vert}^{2}} \cdot {v}_{i} ) + {\sum }_{( i , j ) ∈ E} β \cdot ( \frac{1}{\vert {v}_{i} \vert \cdot \vert {\hat{v}}_{j} \vert} \cdot {\hat{v}}_{i} - \frac{Cos Si m ( {v}_{i} , {v}_{j} )}{{\vert {v}_{i} \vert}^{2}} \cdot {v}_{i} )$$

wherein |\hat{ν}ᵢ| represents a module of the modified word vector νᵢ, |\hat{ν}ᵢ| represents a module of the word vector \hat{ν}ᵢ, and |νⱼ| represents a module of the modified word vector vⱼ.

2) An iterative formula is obtained according to the partial derivation of νᵢ as follows:

$${v}_{i} = {v}_{i} + η \cdot ( α \cdot Cos Sim ( {v}_{i} , {\hat{v}}_{i} ) + {\sum }_{( i , j ) ∈ E} β \cdot Cos Sim ( {v}_{i} , {v}_{j} ) ) \cdot {v}_{i } + η \cdot \vert {v}_{i} \vert \cdot ( \frac{α}{\vert {\hat{v}}_{i} \vert} \cdot {\hat{v}}_{i} + {\sum }_{( i , j ) ∈ E} \frac{β}{\vert {v}_{j} \vert} \cdot {v}_{j} )$$

wherein η represents a learning rate, which may be set as η=0.005.

3) A number T of iterations serves as a termination condition, T=10 is set, a better convergence effect may be achieved in a short time, and the modified word vector is obtained through iteration, which is used as a final word vector after the joint processing.

3 Event-Driven Service Matching Model

In an event-driven service provided, an event is a special service requester. Although information of the event may represent a state change of a related object, the information cannot be directly expressed as a service request. Therefore, this application defines two event-related services which include an event recognition service (ERS) and an event handling service (EHS), the event is respectively used as an output attribute and an input attribute of the ERS and the EHS, and an event-driven semantic IoT service matching model is provided. In an aspect of service description, the service is described by using OWL-S, and according to a representation form of a description logic, the event recognition service and the event handling service are defined as follows:

Event⊆ERS·hasOutput

Event⊆EHS·hasInput.

Then, the event-driven service matching model is as follows:

$$match ( E RS , EHS ) = \{ \begin{matrix}1 & Sim ( {E}_{r} , {E}_{h} ) \geq τ \\ 0 & others\end{matrix} .$$

Wherein Eᵣ and Eₕ respectively represent the output of the ERS and the input of the EHS, T represents a threshold, Sim(Eᵣ, Eₕ) represents a matching degree between the ERS and the EHS, and when the matching degree is higher than the threshold, the matching is successful.

The service matching degree Sim(Eᵣ, Eₕ) is expressed as:

$$Sim ( {E}_{r} , {E}_{h} ) = {\sum }_{a ∈ attr ( {E}_{r} )} {W}_{a} \cdot {Sim}_{a} ( {E}_{r}^{a} , {E}_{h} ) .$$

Wherein attr(Eᵣ) represents an attribute collection (including time, location, object, and the like) of Eᵣ, and Wₐ represents a weight of the attribute a, which is specifically

$${W}_{a} = \frac{1}{\vert attr ( {E}_{r} ) \vert} . The {Sim}_{a} ( {E}_{r}^{a} , {E}_{h} )$$

represents a similarity of Eᵣ between attributes a and Eₕ, which is specifically:

$$S i {m}_{a} ( {E}_{r}^{a} , {E}_{h} ) = \{ \begin{matrix}1 , & {E}_{h} = ∅ \\ 0 & {E}_{h} \neq ∅ ⩔ \vert {E}_{r} \vert ≺ \vert {E}_{h} \vert \\ max \{ s i m ( {E}_{r}^{a} , {E}_{h}^{i} ) \vert i ∈ attr ( {E}_{h} ) \} & others\end{matrix} ;$$

wherein sim(Eᵣ^{a}, Eᵣⁱ) represents a similarity between the attribute a of the event Eᵣ and the attribute i of the event Eₕ, which is obtained by calculating a cosine similarity between the word vectors corresponding to the attributes, which is specifically:

$$s i m ( {E}_{r}^{a} , {E}_{r}^{i} ) = Cos Si m ( x , y ) = \frac{x \cdot y}{‖ x ‖ \cdot ‖ y ‖} ,$$

wherein x and y respectively represent word vectors corresponding to Eᵣ^{a} and Eᵣⁱ.

According to the present invention, an influence of a word frequency on training results is fully considered during word vector training, the word vectors of the high-frequency words and the low-frequency words are obtained by the CBOW Model and the SGM respectively, and then the word vectors are optimized through the CSR Model. With the help of the obtained word vector, a quality of the word vector can be improved. According to the invention, the event recognition service and the event handling service are defined, the event-driven service matching model is built, the service matching degree is calculated through the word vectors, the problem of automatic service matching is solved, and an efficiency and an accuracy of service matching are improved. Automatic service matching is implemented by building the event-driven service matching model.

1. A word vector-based event-driven service matching method, characterized in that, the method comprises two parts of: acquiring high-quality word vectors by a mixed word vector training algorithm; and performing event-driven service matching by using an event-driven service matching model;
wherein acquiring the high-quality word vectors by the mixed word vector training algorithm comprises: dividing words into high-frequency words and low-frequency words, and obtaining word vectors through three stages, including high-frequency word processing, low-frequency word processing and joint processing, by an adjacency relationship between words in a corpus and a semantic relationship between words in a dictionary; and
the event-driven service matching model defines two event-related services which comprise an event recognition service and an event handling service, and calculates a matching degree between the services by using the word vectors; when the matching degree is higher than a given threshold, the matching is successful.

2. The word vector-based event-driven service matching method according to claim 1, wherein in the stage of high-frequency word processing, according to the adjacency relationship between the words in the corpus, a continuous bag of words (CBOW) model is employed for training to obtain high-frequency word vectors.

3. The word vector-based event-driven service matching method according to claim 2, wherein in the stage of low-frequency word processing, according to the semantic relationship between the words in the dictionary and the obtained high-frequency word vectors, a semantic generation model (SGM) is employed to construct low-frequency word vectors.

4. The word vector-based event-driven service matching method according to claim 1, wherein in the stage of joint processing, a cosine similarity retrofitting (CSR) model is employed to perform joint optimization on high-frequency word vectors and low-frequency word vectors.

5. The word vector-based event-driven service matching method according to claim 1, wherein in the event-driven service matching model, an event is respectively used as an output of the event recognition service (ERS) and an input of the event handling service (EHS), which are expressed as Event⊆ERS·hasOutput and Event⊆EHS·hasInput by a description logic, wherein Event represents a concept of the event, ERS represents a concept of the event recognition service, EHS represents a concept of the event handling service, hasOutput represents an output relationship, and hasInput represents an input relationship; and the service matching model is given as follows:
$$match ( E RS , EHS ) = \{ \begin{matrix}1 & Sim ( {E}_{r} , {E}_{h} ) \geq τ \\ 0 & others\end{matrix} ,$$
wherein Eᵣ an Eₕ are both events, which respectively represent the output of the event recognition service and the input of the event handling service, τ represents a threshold, and Sim(Eᵣ, Eₕ) represents the matching degree serving the event recognition service and the event handling service.

6. The word vector-based event-driven service matching method according to claim 5, wherein the service matching degree Sim(Eᵣ, Eₕ) is expressed as:
$$Sim ( {E}_{r} , {E}_{h} ) = {\sum }_{a ∈ attr ( {E}_{r} )} {W}_{a} \cdot {Sim}_{a} ( {E}_{r}^{a} , {E}_{h} )$$
wherein a represents a certain attribute of the event, attr(Eᵣ) represents an attribute collection of Eᵣ, and Wₐ represents a weight of the attribute a, which is specifically
$${W}_{a} = \frac{1}{\vert attr ( {E}_{r} ) \vert} ;$$
the Simₐ(Eᵣ^{a}, Eₕ) represents a similarity of Eᵣ between attributes a and Eₕ, which is specifically:
$$Si {m}_{a} ( {E}_{r}^{a} , {E}_{h} ) = \{ \begin{matrix}1 , & {E}_{h} = ∅ \\ 0 & {E}_{h} \neq ∅ ⩔ \vert {E}_{r} \vert ≺ \vert {E}_{h} \vert \\ max \{ s i m ( {E}_{r}^{a} , {E}_{h}^{i} ) \vert i ∈ attr ( {E}_{h} ) \} & others\end{matrix} ,$$
wherein sim(Eᵣ^{a}, Eᵣⁱ) represents a similarity between the attribute a of the event Eᵣ and the attribute i of the event Eₕ, which is obtained by calculating a cosine similarity between the word vectors corresponding to the attributes, which is specifically:
$$si m ( {E}_{r}^{a} , {E}_{r}^{i} ) = Cos Si m ( x , y ) = \frac{x \cdot y}{‖ x ‖ \cdot ‖ y ‖}$$
wherein x and y respectively represent word vectors corresponding to Eᵣ^{a} and Eᵣⁱ, and ∥x∥ and ∥y∥ respectively represent modules of x and y.
